(19) United States
(12) Patent Application Publication
(10) Pub. No.: US 2014/0168965 A1
(43) Pub. Date: Jun. 19, 2014

(54) LED DEVICE HAVING ADJUSTABLE COLOR TEMPERATURE

(71) Applicants: Kyung Mi Moon, Suwon-si (KR); Young Jin Lee, Seoul (KR); Jung Hye Chae, Suwon-si (KR); Hyung Kun Kim, Suwon-si (KR)

(72) Inventors: Kyung Mi Moon, Suwon-si (KR); Young Jin Lee, Seoul (KR); Jung Hye Chae, Suwon-si (KR); Hyung Kun Kim, Suwon-si (KR)

(73) Assignee: SAMSUNG ELECTRONICS CO., LTD., Suwon-si (KR)

(21) Appl. No.: 14/236,369

(22) PCT Filed: Aug. 16, 2011
(86) PCT No.: PCT/KR2011/005991

§ 371 Date: Jan. 31, 2014

(51) Int. Cl. F21K 99/00

(52) U.S. Cl. CPC F21K 9/56
USPC 362/231

(57) ABSTRACT

An LED device according to an embodiment of the present invention may include a first LED light source unit including at least one first white LED and emitting white light of a first color temperature; a second LED light source unit including at least one second white LED and emitting white light of a second color temperature different from the first color temperature; and a variable resistor connected to at least one of the first LED light source unit and the second LED light source unit, being configured to control a current supplied to the at least one of the first LED light source unit and the second LED light source unit.

### TECHNICAL FIELD

The present invention relates to a light emitting diode (LED) device, and more particularly, to a color temperature controllable white LED, and an LED device capable of implementing high color rendering properties and white light or full color light of various color temperatures, while maintaining luminous flux by including the LED.

### BACKGROUND ART

Recently, light emitting diodes (LEDs) have been prominent as light sources of lighting devices or backlights. In particular, white LEDs may be advantageous in terms of improvements in performance, such as improvements in color reproduction, as well as having reduced power consumption and being environmentally friendly, and have received considerable attention as leading white light sources for lighting devices, capable of replacing existing fluorescent lamps. The white LED may include an LED chip having a short wavelength and a phosphorphosphor absorbing light emitted from the chip and converting a short wavelength of the light into a long wavelength of light, to allow for the mixture of the light emitted from the LED chip and the light from the phosphorphosphor, thereby realizing while light. In the white LED formed as described above, changes in color temperature, in particular, correlated color temperature (simply referred to as CCT) may be implemented depending on a level of current injected into the LED chip, but a range of the implemented color temperature may be significantly narrow. Moreover, in terms of changes in quantity of light depending on a level of the current applied to the LED chip, it may be impossible to perform a substantially wide range of color tuning using a single LED chip, without a reduction in quantity of light.

A method of using various types of single color LED chip in order to implement various kinds of white light exists. For example, white light may be implemented by mixing red, blue and green LEDs. The red, blue and green LEDs may exhibit a spectrum generated through the emission of light due to a transition in the band gap of a semiconductor layer, unlike a fluorescence spectrum generated by a phosphor and thus, may be single color light sources having a significantly narrow full width at half maximum of 20 nm or less. Thus, various color coordinates may be implemented through the mixture of the red, blue and green LEDs, but the securing of natural white light having a high color rendering index (CRI) may not be facilitated.

As a further improved method, an LED device including a single white LED and individual LEDs having red, blue and green wavelengths to separately control the LEDs, thereby implementing white light, has been proposed. However, such an LED device may also implement various color coordinates but may have limitations in implementing high color rendering properties within a wide color temperature range from cool white to warm white, as long as the LED device uses single color light sources in which red, blue and green LEDs have a narrow full width at half maximum.

### DISCLOSURE

### Technical Problem

An aspect of the present invention provides a light emitting diode (LED) device, capable of implementing natural white light having high color rendering properties within a wide color temperature range, while controlling a color temperature.

An aspect of the present invention also provides an LED device, capable of implementing full color light including natural white light having high color rendering properties within a wide color temperature range, while controlling a color temperature and maintaining luminous flux.

### Technical Solution

According to an aspect of the present invention, there is provided an LED device including: a first LED light source unit including at least one first white LED and emitting white light of a first color temperature; a second LED light source unit including at least one second white LED and emitting white light of a second color temperature different from the first color temperature; and a variable resistor connected to at least one of the first LED light source unit and the second LED light source unit, to control a current supplied to the at least one of the first LED light source unit and the second LED light source unit.

The first LED light source unit and the second LED light source unit may be connected in parallel. The first LED light source unit may include a plurality of first white LEDs connected in series. The second LED light source unit may include a plurality of second white LEDs connected in series.

At least one of the first white LED and the second white LED may include a blue LED chip and a yellow phosphor. At least one of the first white LED and the second white LED may include a combination of a blue LED chip, a yellow phosphor, a green phosphor, and a red phosphor. At least one of the first white LED and the second white LED may include a combination of an ultraviolet light (UV) LED chip, a red phosphor, a green phosphor, and a blue phosphor.

The LED device may further include a resin encapsulating part covering the entirety of the first and second LED light source units on a substrate, the first and second LED light source units being disposed on the substrate.

The first color temperature may range from 5000 to 10000K and the second color temperature may range from 2500 to 4000K.

The LED device may further include a red LED, a green LED, and a blue LED, driven separately from the first and second LED light source units. The LED device may enable full color light including white light to be emitted by controlling currents injected into the first and second LED light source units and the red, green, and blue LEDs.

The LED device may further include a resin encapsulating part covering the entirety of the first and second LED light source units and the red, green, and blue LEDs on a substrate, the first and second LED light source units and the red, green, and blue LEDs being disposed on the substrate.

### Advantageous Effects

According to embodiments of the present invention, a color temperature of white light output from an LED device may be controlled, and in white light having various color temperatures, high color rendering properties may be secured. In particular, according to embodiments of the present invention, a ratio between driving currents applied to a cool white LED light source and a warm white LED light source may be controlled, such that natural white light having high color rendering properties on the Planckian locus may be implemented according to the ratio. In addition, in natural white light of various color coordinates, luminous flux may be maintained and high color rendering properties may be secured. The LED device according to the embodiments of the present invention may enable various color temperatures to be implemented and high color rendering properties to be maintained, thereby being effectively applied to a high quality mood lighting device. The LED device according to the embodiments of the present invention may further include red, green and blue LEDs, such that full color illumination having high color rendering properties, as well as white illumination, may be implemented using a single module.

### DESCRIPTION OF DRAWINGS

FIG. 1 is a circuit diagram illustrating an LED device according to an embodiment of the present invention.

FIG. 2 is a schematic perspective view of an LED device 100 according to the embodiment of the present invention.

FIG. 3 is a graph illustrating various spectra obtained from an LED device according to an inventive example of the present invention.

FIG. 4 is a view illustrating various color coordinates of white light obtained from the inventive example of FIG. 3.

FIG. 5 is a schematic perspective view illustrating an LED device according to another embodiment of the present invention.

FIGS. 6a and 6b are views illustrating a spectrum obtained from an LED device according to a comparative example and a spectrum obtained from the LED device according to the inventive example of the present invention, respectively.

### BEST MODE

Hereinafter, embodiments of the present invention will be described in detail with reference to the accompanying drawings. The invention may, however, be embodied in many different forms and should not be construed as being limited to the embodiments set forth herein. In the drawings, the shapes and dimensions of elements may be exaggerated for clarity, and the same reference numerals will be used throughout to designate the same or like elements.

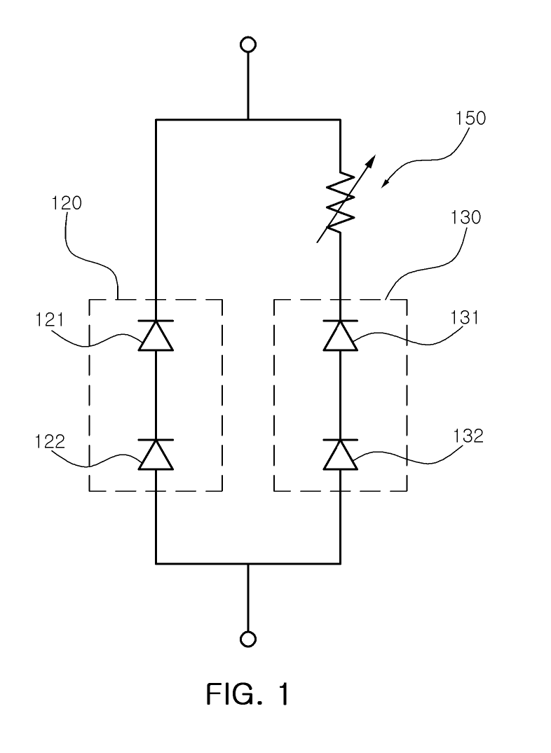

FIG. 1 is a circuit diagram illustrating an LED device according to an embodiment of the present invention. Referring to FIG. 1, the LED device according to the embodiment of the present invention may include a first LED light source unit 120 and a second LED light source unit 130 that emit white light of different color temperatures from each other. White light emitted from the first LED light source unit 120 and white light emitted from the second LED light source unit 130 may be mixed to output white light from the LED device.

Referring to FIG. 1, the first LED light source unit 120 may include at least one first white LED 121 or 122 to emit white light of a first color temperature, and the second LED light source unit 130 may include at least one second white LED 131 or 132 to emit white light of a second color temperature. In the embodiment, the first LED light source unit 120 includes two first white LEDs 121 and 122 and the second LED light source unit 130 includes two second white LEDs 131 and 132, but the present invention is not limited thereto. For example, each of the light source units 120 and 130 may include a single white LED or three or more white LEDs.

As illustrated in FIG. 1, the first LED light source unit 120 and the second LED light source unit 130 that emit white light of different color temperatures from each other may be connected in parallel. For example, the first LED light source unit 120 emitting cool white light and the second LED light source unit 130 emitting warm white light may be connected to each other in parallel. Here, cool white light refers to white light having a relatively high correlated color temperature (CCT), and warm white light refers to white light having a relatively low CCT. The two first white LEDs 121 and 122 included in the first LED light source unit 120 may be connected in series and have the same amount of current injected thereinto.

Further, the LED device may be configured such that a variable resistor 150 may be connected in series to at least one of the first LED light source unit 120 and the second LED light source unit 130 to thereby control the amount of current applied to the first LED light source unit 120 and the second LED light source unit 130. Resistance of the variable resistor 150 may be controlled, such that an effective control of a ratio (current ratio) between the amount of current supplied to the first LED light source unit 120 and the amount of current supplied to the second LED light source unit 120 may be facilitated. Thus, due to the control of the current ratio using the variable resistor, a ratio between a quantity of white light (for example, cool white light) of the first color temperature, emitted from the first LED light source unit 120, and a quantity of white light (for example, warm white light) of the second color temperature, emitted from the second LED light source unit 130, may be varied to thereby control a color temperature of white light outputted from the overall LED device.

The currents of the first and second LED light source units 120 and 130 may be controlled by the variable resistor 150 to control the color temperature of the LED device if necessary, which may be applied to lighting devices to implement a white light illumination device having various color coordinates. The LED device according to the embodiment as described above may be applied to mood lighting devices for ambient environments or desired atmospheric displays. In addition, as described below, the overall luminous flux may be maintained within the overall controllable color temperature range, and a full white light source capable of exhibiting the overall natural white light region from cool white light to warm white light may be implemented. For example, the first white LEDs 121 and 122 may be cool white LEDs having a color temperature of 5000 to 10000K and the second white LEDs 131 and 132 may be warm white LEDs having a color temperature of 2500 to 4000K, to implement an LED device from which light of various color temperatures is output through the control of the variable resistor 150. Furthermore, a sufficiently high color rendering index (CRI) may be maintained within a wide color temperature range as described below, without deteriorations in color rendition.

In the embodiment described above, the variable resistor 150 may be connected to the second LED light source unit 130, but the present invention is not limited thereto. The variable resistor may be connected to the first LED light source unit 120, instead of the second LED light source unit 130, and individual variable resistors may be connected to the first LED light source unit 120 and the second LED light source unit 130. In this case, the current ratio of two light source units may be controlled by controlling the variable resistor, such that the color temperature of the overall output light may be controlled while a sufficient quantity of light and a high degree of color rendition may be maintained.

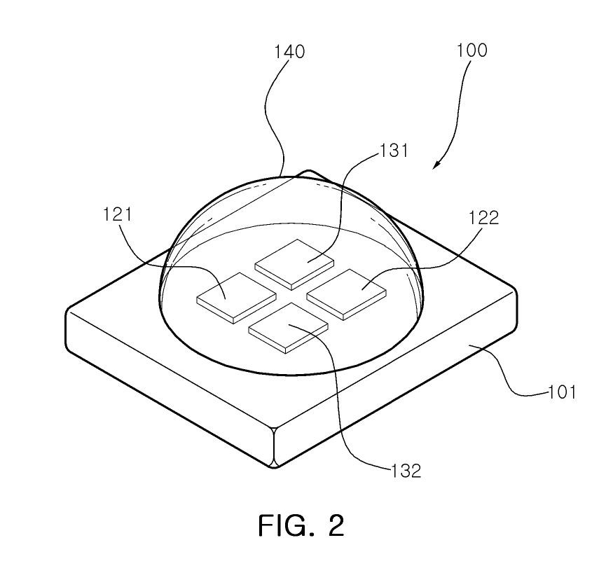

FIG. 2 is a schematic perspective view of an LED device 100 according to the embodiment of the present invention. Referring to FIG. 2, the two first white LEDs 121 and 122 emitting cool white light and the two second white LEDs 131 and 132 emitting warm white light may be disposed on a substrate 101 (for example, a circuit board) provided with wirings. The two first white LEDs 121 and 122 may configure the first LED light source unit (See 120 of FIG. 1) and the two second white LEDs 131 and 132 may configure the second LED light source unit (See 130 of FIG. 1). Electrical connection relationships between the white LEDs 121, 122, 131, and 132 are illustrated in FIG. 1 and the substrate may be provided with the wirings for the connection therebetween. In addition, the variable resistor (see 150 of FIG. 1) may be connected to at least one of the white LEDs 121, 122, 131, and 132. Although a concrete wiring form and the variable resistor on the substrate, provided to implement the connection relationships of FIG. 1 may not be illustrated in FIG. 2, they could be sufficiently understood to a person having ordinary skill in the art from FIG. 1 and a description of the specification. The white LEDs having different color temperatures may be spatially mixed with each other to facilitate a uniform mixture of different types of white light.

Each of the white LEDs 121, 122, 131, and 132 may be implemented through a combination of an LED chip and a phosphor. For example, at least one of the first white LEDs 121 and 122 and the second white LEDs 131 and 132 may include a blue LED chip and a yellow phosphor. Alternatively, at least one of the white LEDs 121, 122, 131, and 132 may include a combination of a blue LED chip, a yellow phosphor, a green phosphor, and a red phosphor, to emit white light. Alternatively, at least one of the white LEDs 121, 122, 131, and 132 may include a combination of an ultraviolet light (UV) LED chip, a red phosphor, a green phosphor, and a blue phosphor, to emit white light. The different color temperatures may be implemented depending on the selection of wavelengths of respective white LED chips and phosphor materials. The phosphor to be combined with the LED chip may be directly coated on a light emitting surface of the LED chip and may be disposed to be spaced apart from the LED chip. Moreover, the phosphor may be mixed with an appropriate transparent resin and may be provided in the form of an optical conversion resin layer containing phosphors (dispersed phosphors).

As illustrated in FIG. 2, a transparent resin encapsulating part 140 covering the entirety of the first white LEDs 121 and 122 emitting cool white light and the second white LEDs 131 and 132 emitting warm white light at the same time may be disposed on the substrate 101. The resin encapsulating part 140 may serve to mix white light of different color temperatures, emitted from the first white LEDs 121 and 122 and the second white LEDs 131 and 132. In addition, the resin encapsulating part 140 may have an upwardly convex shape or a hemispherical shape, thereby serving as a type of lens.

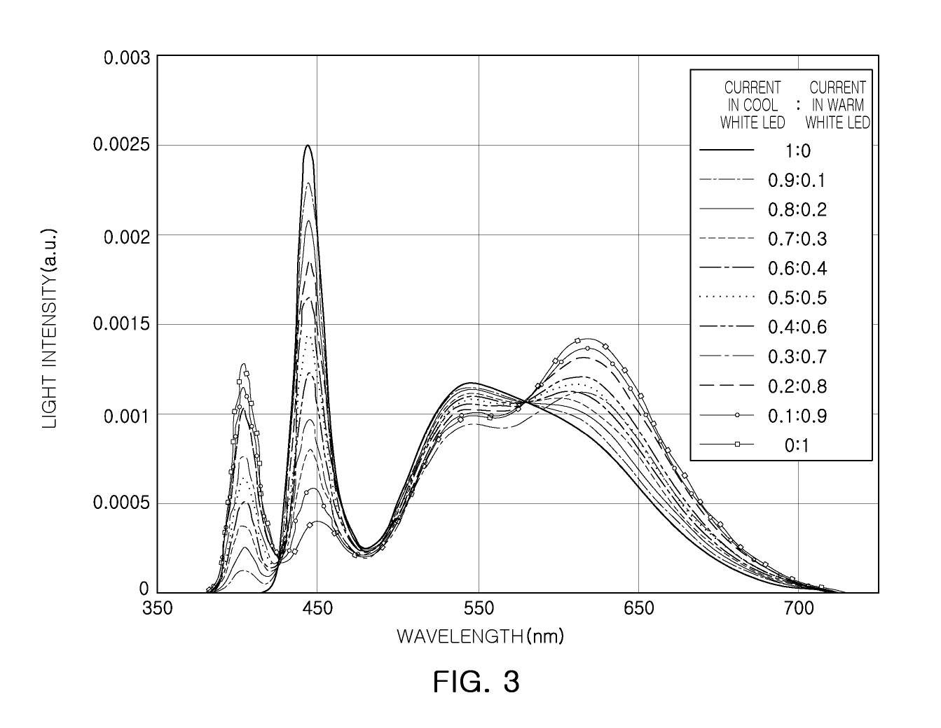

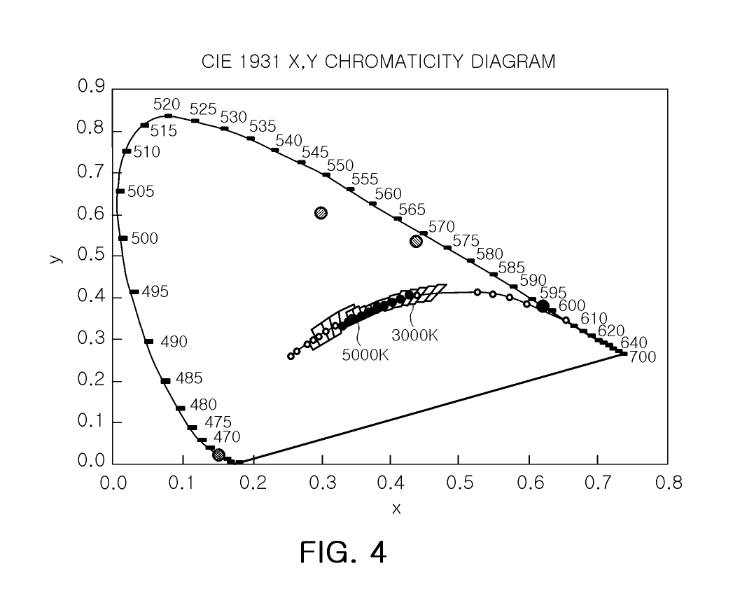

FIG. 3 is a graph illustrating various spectra obtained from an LED device according to an inventive example of the present invention. FIG. 4 is a view illustrating various color coordinates (black dots) of white light obtained from the inventive example of FIG. 3. The spectra and color coordinate data illustrated in FIGS. 3 and 4 were obtained from the LED device having the configuration described with reference to FIGS. 1 and 2. More specifically, as the first white LEDs 121 and 122 having the first color temperature, cool white LEDs (CRI=78.6) including a combination of a blue LED chip, a yellow phosphor, a green phosphor, and a red phosphor and having a color temperature of 5625K were used. As the second white LEDs 131 and 132 having the second color temperature, warm white LEDs (CRI=88.7) including a combination of an ultraviolet light (UV) LED chip, a red phosphor, a green phosphor, and a blue phosphor and having a color temperature of 3000K were used. Due to the control of the variable resistor (see 150 of FIG. 1), the current ratio (current in cool white LED: current in warm white LED) between a current supplied to the cool white LEDs and a current supplied to the warm white LEDs may be controlled. Depending on the current ratio (current in cool white LED: current in warm white LED), light output from the LED device may exhibit various spectra as illustrated in FIG. 3 and may be shown as white light having various color coordinates and color temperatures as illustrated in FIG. 4.

Color coordinates (x, y), luminous flux, a correlated color temperature (CCT), and a color rendering index (CRI) depending on the current ratio (current in cool white LED: current in warm white LED) of the LED device according to the inventive example of FIGS. 3 and 4 are described in the following Table 1.

TABLE 1

| | | Current | | | |
|---|---|---|---|---|---|
| | | in cool | | | |
| | | white | | | |
| | | LED:current | Quantity | | |
| | | in warm | of light | | |
| x | y | white LED | (lm) | CCT | CRI |
| 0.444 | 0.418 | 0:1 | 71.3 | 3002 | 88.7 |
| 0.4300 | 0.4070 | 0.1:0.9 | 71.32 | 3155 | 87.9 |
| 0.4160 | 0.3970 | 0.2:0.8 | 71.33 | 3325 | 87.1 |
| 0.4040 | 0.3880 | 0.3:0.7 | 71.35 | 3513 | 86.3 |
| 0.3920 | 0.3790 | 0.4:0.6 | 71.36 | 3724 | 85.5 |
| 0.3800 | 0.3700 | 0.5:0.5 | 71.37 | 3959 | 84.6 |
| 0.3690 | 0.3620 | 0.6:0.4 | 71.39 | 4222 | 83.6 |
| 0.3590 | 0.3540 | 0.7:0.3 | 71.4 | 4516 | 82.5 |
| 0.3490 | 0.3460 | 0.8:0.2 | 71.41 | 4845 | 81.3 |
| 0.3390 | 0.3390 | 0.9:0.1 | 71.43 | 5213 | 79.8 |
| 0.3300 | 0.3320 | 1:0 | 71.44 | 5625 | 78.6 |

As described in Table 1, natural white light of various combinations could be implemented and it could be confirmed that in natural white light of various combinations, the luminous flux was maintained and a high CRI was secured.

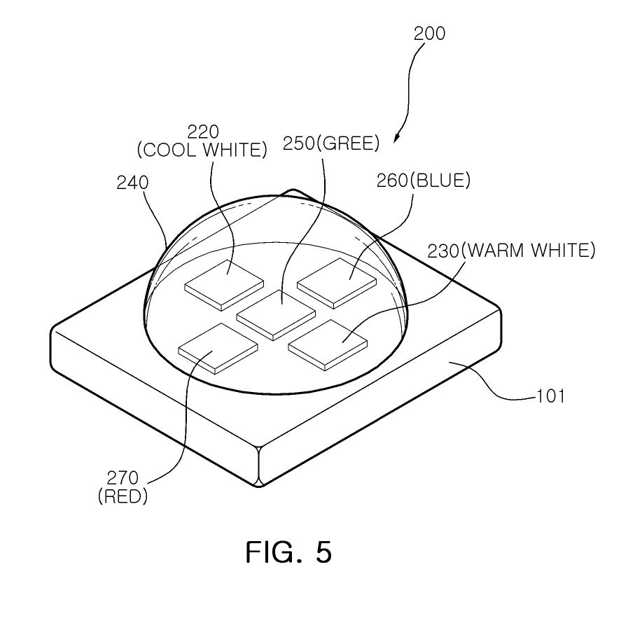

FIG. 5 is a schematic perspective view illustrating an LED device according to another embodiment of the present invention. In the embodiment of FIG. 5, an LED device 200 may include a cool white LED 220 having a first color temperature and a warm white LED 230 having a second color temperature on the substrate 101 and may further include single color LEDs including green, blue and red LEDs 250, 260, and 270 on the substrate 101. In a similar manner as described with reference to FIG. 1, the cool white LED 220 (corresponding to the first LED light source unit 120 of FIG. 1) and the warm white LED 230 (corresponding to the second LED light source unit 130 of FIG. 1) may be connected to each other in parallel. A variable resistor may be connected to at least one of the cool white LED 220 and the warm white LED 230. Although FIG. 5 illustrates a single cool white LED 220 and a single warm white LED 230, two or more cool white LEDs or warm white LEDs may be provided as illustrated in FIGS. 1 and 2, and LEDs having the same color temperature may be connected to each other in series.

Wirings may be provided on the substrate 101 such that the green, blue, and red LEDs 250, 260 and 270 that are further included in the LED device 200 may be driven separately from the white LEDs 220 and 230. The green, blue, and red LEDs 250, 260 and 270 may be separately driven, or a current supplied to the respective single color LEDs or a current ratio therebetween may be controlled. Each of the single color LEDs 250, 260, and 270 may be formed of an LED chip and a transparent resin encapsulating the LED chip and may also be formed of an LED chip without a separate transparent resin or may be provided in the form of a package having an LED chip mounted therein.

According to the embodiment of FIG. 5, due to the control of the variable resistor connected to at least one of the cool white LED 220 and the warm white LED 230, white light of various color temperatures may be easily output from the LED device. In addition, due to the further included single color LEDs such as green, blue and red LEDs 250, 260, and 270, color rendering properties of light output from the LED device 200 may be further significantly increased. Moreover, a current supplied to the white LEDs 220 and 230 and the current supplied to the single color LEDs 250, 260 and 270 may be controlled, such that light of different colors may be output from the LED device, thereby implementing full color light including white light. Such a white LED device 200 may be applied to lighting devices to allow for mood lighting devices capable of controlling a color and a color temperature within a wide range from bluish light to red light while passing through cool white light and warm white light.

As illustrated in FIG. 5, a resin encapsulating part 240 may cover the entirety of the cool white LED 220, the warm white LED 230, the green LED 250, the blue LED 260, and the red LED 270 at the same time on the substrate. The resin encapsulating part 240 may be formed to have an appropriate shape in order to serve as a lens. The resin encapsulating part 240 may serve to further smoothly mix light emitted from the respective LEDs.

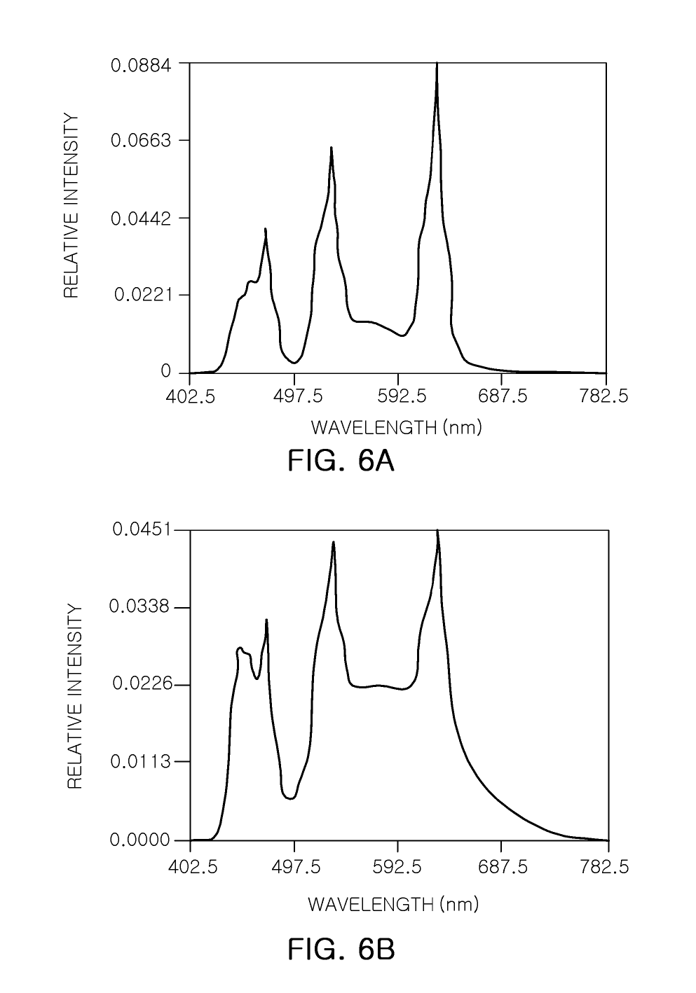

FIGS. 6a and 6b are views illustrating a spectrum obtained from an LED device according to the comparative example and a spectrum obtained from the LED device according to the inventive example of the present invention, respectively. The LED device according to the comparative example, exhibiting the spectrum of FIG. 6a, was implemented through a combination of a cool white LED having a color temperature below 4500K and a red phosphor, a green phosphor, and a blue phosphor. The LED device according to the inventive example of the present invention, exhibiting the spectrum of FIG. 6B, was implemented through a combination of cool and warm white LEDs and a red phosphor, a green phosphor, and a blue phosphor, as illustrated in FIG. 5. In order to compare the comparative example with the inventive example of the present invention, the LED devices according to the comparative example and the inventive example of the present invention were driven to emit white light having almost the same color coordinates and color temperature (neutral white of 4500K or less). The spectra of FIGS. 6a and 6b are spectra in the almost same color coordinates and color temperature. Color coordinates (x, y), correlated color temperatures (CCT) and color rendering indices (CRI) depending on the spectra of the comparative example and the inventive example of the present invention illustrated in FIGS. 6a and 6b are described in the following Table 2.

TABLE 2

| | x | y | CCT | CRI |
|---|---|---|---|---|
| Comparative | 0.36303 | 0.37699 | 4504 | 72.55 |
| Example, | | | | |
| FIG. 6a | | | | |
| Inventive | 0.36274 | 0.37437 | 4499 | 94.38 |
| Example, | | | | |
| FIG. 6b | | | | |

As illustrated in FIGS. 6a and 6b and Table 2, the almost same color coordinates and color temperatures were shown in the comparative example and the inventive example. However, in terms of color rendering indices (CRI), the comparative example having no warm white LED, exhibited a color rendering index of 72.55, while the inventive example having the warm white LED in addition to the cool white LED, exhibited a high color rendering index of 94.38.

While the present invention has been shown and described in connection with the embodiments, it will be apparent to those skilled in the art that modifications and variations can be made without departing from the spirit and scope of the invention as defined by the appended claims.

1. An LED device, comprising:
a first LED light source unit including at least one first white LED and emitting white light of a first color temperature;
a second LED light source unit including at least one second white LED and emitting white light of a second color temperature different from the first color temperature; and
a variable resistor connected to at least one of the first LED light source unit and the second LED light source unit, being configured to control a current supplied to the at least one of the first LED light source unit and the second LED light source unit.

2. The LED device of claim 1, wherein the first LED light source unit and the second LED light source unit are connected in parallel.

3. The LED device of claim 1, wherein the first LED light source unit includes a plurality of first white LEDs connected in series.

4. The LED device of claim 1, wherein the second LED light source unit includes a plurality of second white LEDs connected in series.

5. The LED device of claim 1, wherein at least one of the first white LED and the second white LED includes a blue LED chip and a yellow phosphor.

6. The LED device of claim 1, wherein at least one of the first white LED and the second white LED includes a blue LED chip, and a combination of a yellow phosphorphosphor, a green phosphorphosphor, and a red phosphorphosphor.

7. The LED device of claim 1, wherein at least one of the first white LED and the second white LED includes an ultraviolet light (UV) LED chip, and a combination of a red phosphorphosphor, a green phosphorphosphor, and a blue phosphorphosphor.

8. The LED device of claim 1, further comprising: a resin encapsulating part covering the entirety of the first and second LED light source units on a substrate, the first and second LED light source units being disposed on the substrate.

9. The LED device of claim 1, wherein the first color temperature ranges from 5000 to 10000K and the second color temperature ranges from 2500 to 4000K.

10. The LED device of claim 1, further comprising: a red LED, a green LED, and a blue LED, driven separately from the first and second LED light source units.

11. The LED device of claim 10, wherein the LED device enables full color light including white light to be emitted by controlling currents injected into the first and second LED light source units and the red, green, and blue LEDs.

12. The LED device of claim 10, further comprising: a resin encapsulating part covering the entirety of the first and second LED light source units and the red, green, and blue LEDs on a substrate, the first and second LED light source units and the red, green, and blue LEDs being disposed on the substrate.
